(19) United States
(12) Patent Application Publication
(10) Pub. No.: US 2015/0057049 A1
(43) Pub. Date: Feb. 26, 2015

(54) ELECTRONIC DEVICE HAVING MOVABLE DISPLAY

(71) Applicants: Hon Hai Precision Industry Co., Ltd., New Taipei (TW); Hong Fu Jin Precision Industry (ShenZhen) Co., Ltd., Shenzhen (CN)

(72) Inventor: XIN YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,392

(22) Filed: Aug. 30, 2013

(30) Foreign Application Priority Data
Aug. 20, 2013 (CN) 2013103636828

(51) Int. Cl. H04M 1/02

(52) U.S. Cl. CPC H04M 1/0266; H04M 1/0235
USPC 455/566

(57) ABSTRACT

An electronic device includes a base, a display, a slide apparatus installed between the base and the display, and an operation apparatus. The slide apparatus includes a rack mounted to the display, a gear pivotably installed to the base and engaging with the rack, and a resilient clamping member. A protrusion protrudes out from the gear. A pole protrudes out from the protrusion and deviates from an axis of the gear. The clamping member comprises two resilient clamping plates sandwiching the protrusion. The operation apparatus includes an operation member and an adjusting member rotatably connected between the operation member and the pole. The operation member is slid, and the adjusting member is driven to rotate the gear and the protrusion. The protrusion slidably abuts against the clamping plates, deforming the clamping plates, until two opposite ends of the protrusion are across middle portions of the clamping plates.

### BACKGROUND

1. Technical Field

The disclosure relates to an electronic device with a movable display.

2. Description of Related Art

Displays of some electronic devices are movable for convenient operation and to save space. For example, a slide mobile phone generally has a main body and a display slidably mounted to the main body. The user pushes the display relative to the main body to operate the phone. However, the displays are easily abraded by user's pushing.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of an electronic device, wherein the electronic device includes a slide apparatus and an operation apparatus, and the slide apparatus includes a transmission mechanism.

FIG. 2 is an exploded, isometric view of the transmission mechanism of FIG. 1.

FIG. 3 is an exploded, isometric view of the operation apparatus of FIG. 1.

FIG. 4 is a partially assembled, isometric view of FIG. 1.

FIG. 5 is an assembled, isometric view of FIG. 1.

FIG. 6 is a cross-sectional view of FIG. 5, taken along the line of VI-VI.

FIGS. 7 and 8 are similar to FIG. 6, but showing two different states of the electronic device of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

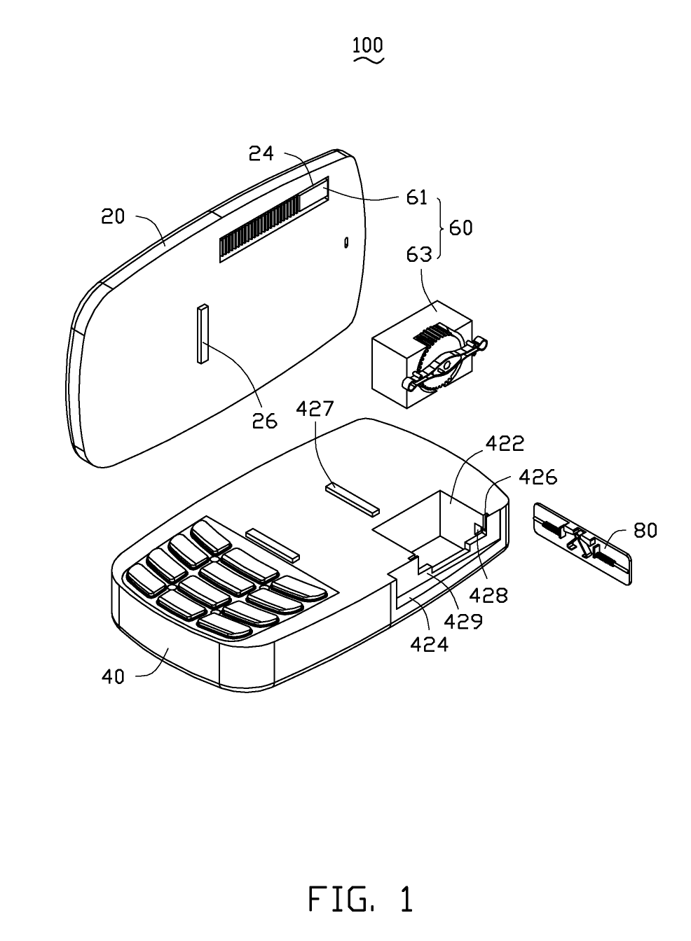

FIG. 1 shows an electronic device 100 of the embodiment. The electronic device 100 includes a display 20, a base 40, a slide apparatus 60, and an operation apparatus 80.

A bottom surface of the display 20 defines a long receiving slot 24 extending along lengthwise of the display 20. The receiving slot 24 is located in a side of a front end of the display 20. A positioning bar 26 protrudes down from a middle of the bottom surface of the display 20, and extends along widthwise of the display 20.

A top surface of the base 40 defines a rectangular receiving space 422. The receiving space 422 is located in a side of a front end of the base 40. The side of the base 40 defines a guiding slot 424 communicating with the receiving space 422. The base 40 defines two opposite guiding holes 426 in a junction of the receiving space 422 and the guiding slot 424. Opposite inner walls of the receiving space 422 define two receiving holes 428 adjacent to the guiding slot 424. A bottom of the junction of the receiving space 422 and the guiding slot 424 defines a cutout to form two opposite stopping blocks 429. Two spaced stopping bars 427 protrude up from a middle of the top surface of the base 40, and are arranged in a fore-and-aft direction of the base 40.

The slide apparatus 60 includes a rack 61 mounted in the receiving slot 24 of the display 20 and a transmission mechanism 63.

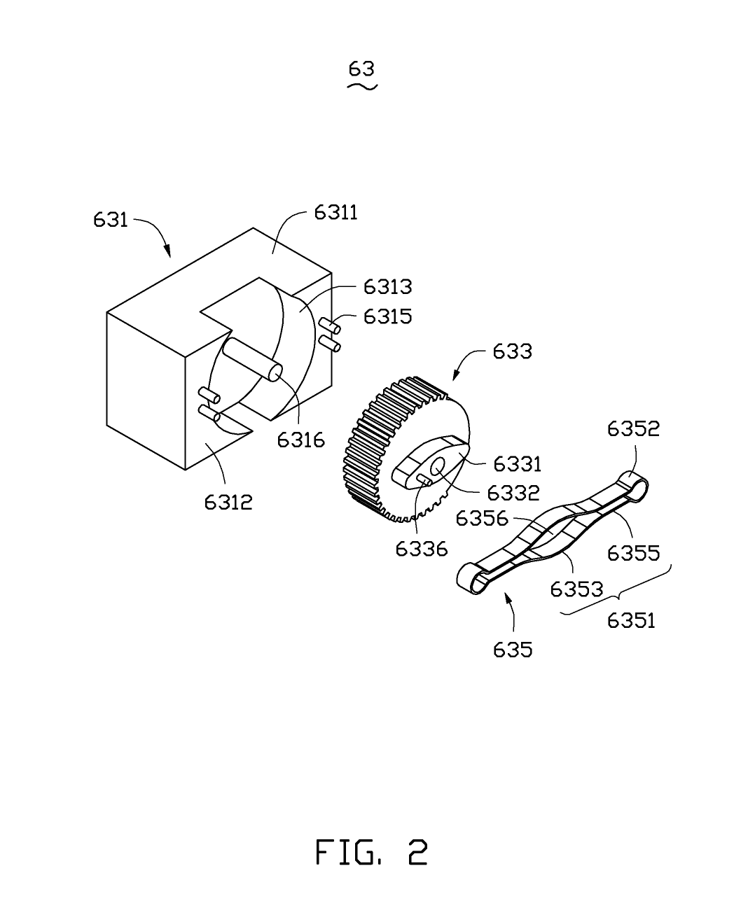

FIG. 2 shows the transmission mechanism 63 including a bracket 631, a gear 633, and a resilient clamping member 635.

The bracket 631 is substantially rectangular, and includes a top surface 6311 and a side surface 6312 perpendicularly extending down from a side of the top surface 6311. A middle of the side surface 6312 defines a circular recess 6313. The recess 6313 extends through the top surface 6311. Two pairs of spaced pins 6315 perpendicularly extend out from two opposite ends of the side surface 6312 and adjacent to the recess 6313. A shaft 6316 perpendicularly extends out from a middle of an inner wall of the recess 6313 opposite to the side surface 6312. An axis of the shaft 6316 is coaxial with an axis of the recess 6313.

An ellipse-shaped protrusion 6331 protrudes out from a middle of a side of the gear 633. The middle of the gear 633 axially defines a shaft hole 6332 extending through a middle of the protrusion 6331. Two opposite ends of the protrusion 6331 deviate from the axis of the gear 633. A pole 6336 perpendicularly protrudes out from one of the ends of the protrusion 6331. An axis of the pole 6336 deviates from the axis of the gear 633.

The clamping member 635 includes two opposite and resilient clamping plates 6351, and two opposite and substantially C-shaped connecting plates 6352 connected between corresponding ends of the clamping plates 6351. Each connecting plate 6352 protrudes away from the clamping plates 6351. Each clamping plate 6351 includes an arc-shaped clamping portion 6353 arced away from the opposite clamping plate 6351, and two connecting portions 6355 connected between two opposite ends of the clamping portions 6353 and the corresponding connecting plates 6352. The clamping portions 6353 cooperatively bound an ellipse-shaped clamping space 6356. In the embodiment, the clamping member 635 is made of resilient material, and is integrally formed.

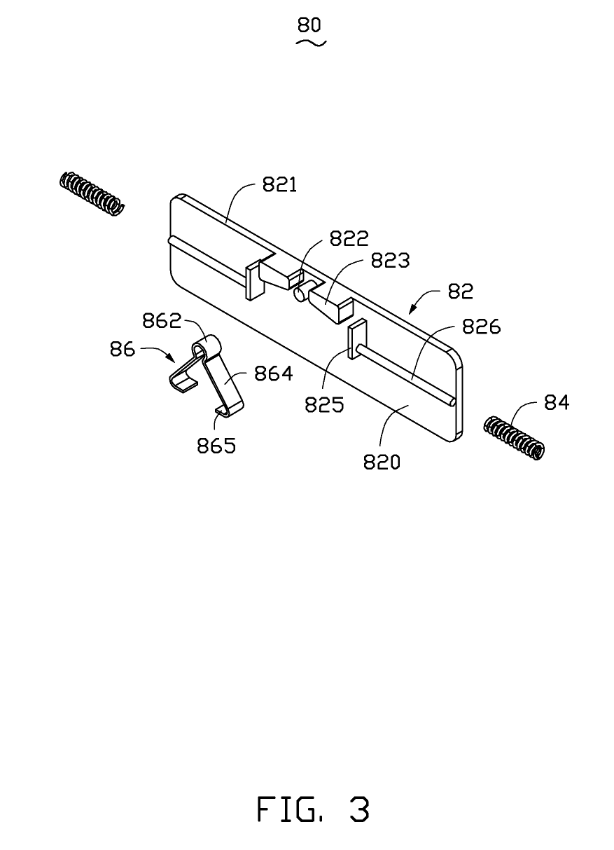

FIG. 3 shows the operation apparatus 80 including an operation member 82, two resilient members 84, and an adjusting member 86.

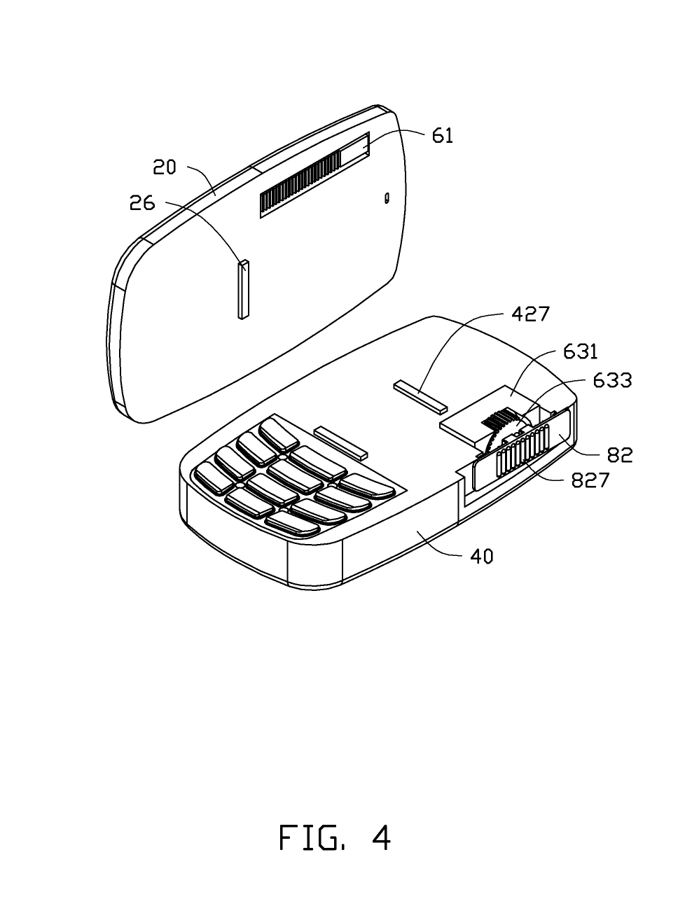

The operation member 82 includes a rectangular sliding plate 821. The sliding plate 821 includes an inner side surface 820. A connecting shaft 822 perpendicularly protrudes out from a middle of an upper side of the inner side surface 820. Two opposite tabs 823 protrude out from the inner side surface 820, and are located at two opposite sides of the connecting shaft 822. Two pieces 825 protrude out from a middle of the inner side surface 820, and adjacent to the tabs 823. Two guiding poles 826 extend from the pieces 825 away from each other. Each guiding pole 826 is spaced and parallel to the sliding plate 821. A plurality of skid-proof bars 827 protrudes out from an outer side surface of the sliding plate 821 opposite to the inner side surface 820 (shown in FIG. 4).

In the embodiment, each resilient member 84 is a coil spring.

The adjusting member 86 is substantially triangular and includes a substantially C-shaped rotation portion 862, two connecting pieces 864 slantingly extending down from two opposite distal ends of the rotation portion 862 and away from each other, and two hooks 865 formed on distal ends of the connecting pieces 864. The hooks 865 extend toward each other.

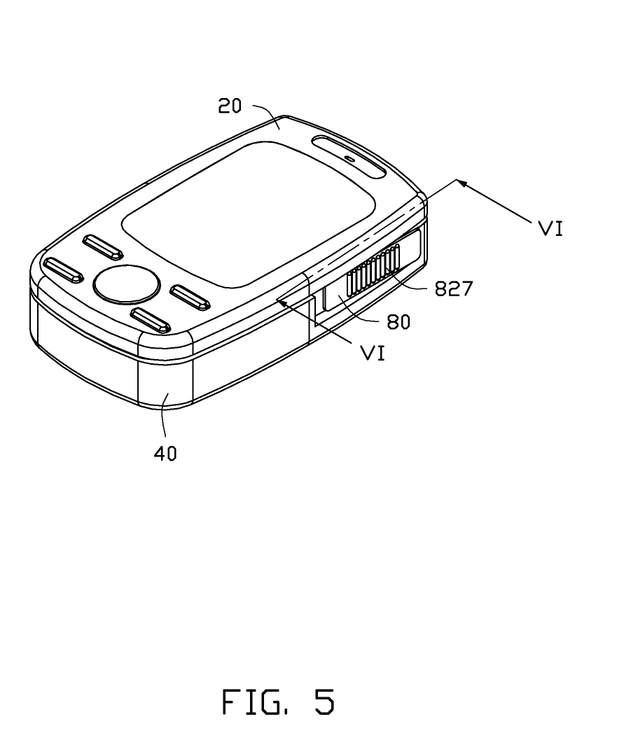

FIGS. 4 and 5 show that in assembly of the electronic device 100, the shaft 6316 of the bracket 631 is inserted in the shaft hole 6332 of the gear 633 from a side surface of the gear 633 opposite to the protrusion 6331. The connecting portions 6355 of the clamping member 635 are slidably sandwiched between the two pairs of the pins 6315, and the protrusion 6331 is received in the clamping space 6356. Thus, the gear 633 is rotatably received in the recess 6313, and a portion of the gear 633 is exposed out of the top surface 6311 of the bracket 631.

In assembly of the operation apparatus 80, the resilient members 84 are fitted about the guiding poles 826 of the operation member 82. The rotation portion 862 of the adjusting member 86 is fitted about the connecting shaft 822 of the operation member 82.

The transmission mechanism 63 is received in the receiving space 422 of the base 40, the pole 6336 is received in the guiding slot 424 of the base 40, and the connecting plates 6352 of the clamping member 635 are received in the receiving holes 428 of the base 40. The portion of the gear 633 is exposed out of the top surface of the base 40. The operation apparatus 80 is received in the guiding slot 424 of the base 40, and distal ends of the guiding poles 826 are slidably inserted into the guiding holes 426 of the base 40. The resilient members 84 are sandwiched between the pieces 825 and the base 40. The operation member 82 is slidably received in the guiding slot 424 of the base 40. The pole 6336 of the gear 633 is located between the hooks 865 of the adjusting member 86. The display 20 is covered on the base 40, to allow the rack 61 to engage with the gear 633. The positioning bar 26 is stopped between the stopping bars 427 of the base 40.

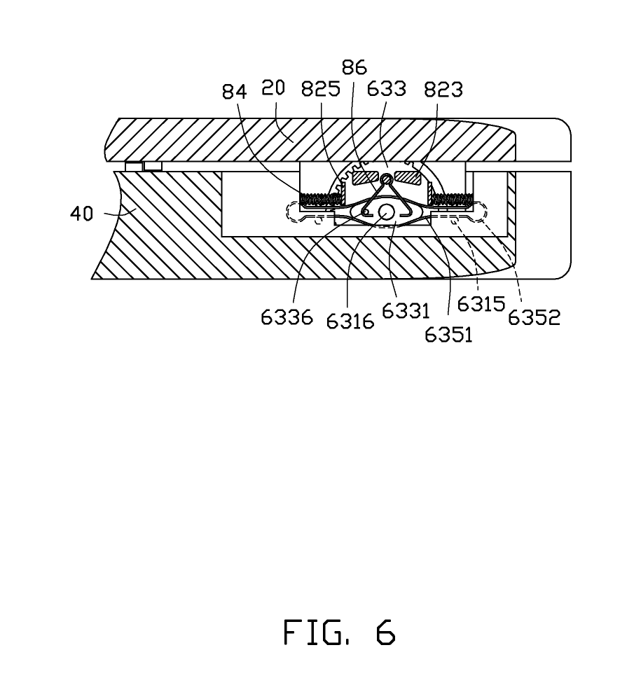

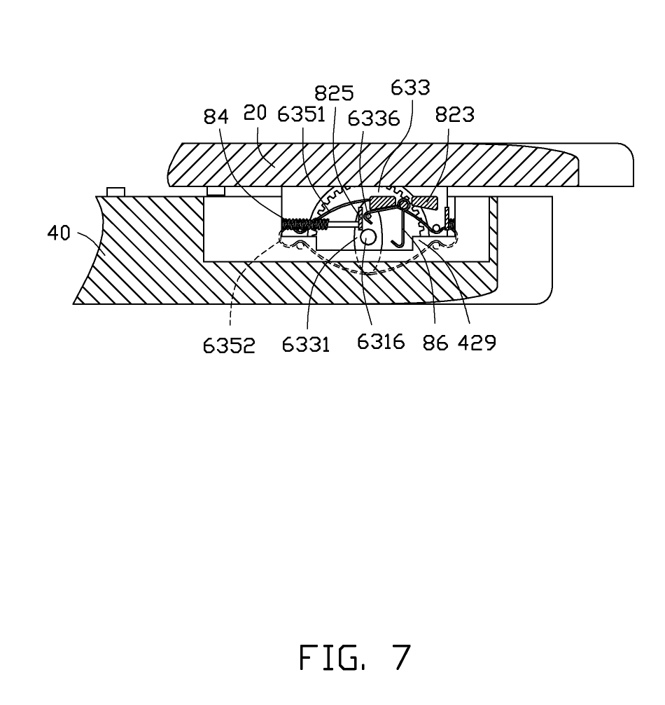

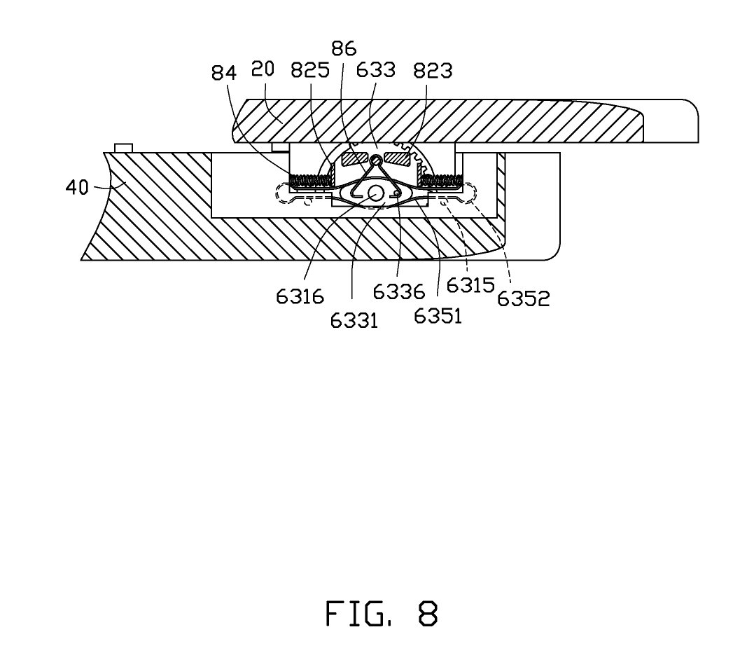

FIGS. 6-8 show that in use, the skid-proof bars 827 of the operation member 82 is pushed forward, to slide the sliding plate 821 forward along the guiding slot 424. The guiding poles 826 slide forward along the guiding holes 426. The resilient member 84 positioned at the front of the operation member 82 is pressed, to be deformed. The pole 6336 is latched in the hook 865 positioned at a rear of the adjusting member 86. The pole 6336 is rotated up about the shaft 6316, to pivot the gear 633 clockwise. The gear 633 drives the rack 24 to move forward, to slide the display 20 forward relative to the base 40. The adjusting member 86 is blocked between the tab 823 positioned at the rear of the operation member 82 and the stopping block 429 positioned at the front end of the base 40. The opposite ends of the protrusion 6331 slidably abut against inner surfaces of the clamping portions 6353, deforming the clamping plates 6351, until the opposite ends of the protrusion 6331 substantially abut against middle portions of the clamping portions 6353. The connecting plates 6352 are blocked by the two pairs of pins 6315. The skid-proof bars 827 are further pushed forward, until the opposite ends of the protrusion 6331 are across the middle portions of the clamping portions 6353, the clamping plates 6351 are restored to rotate the protrusion 6331 clockwise. The gear 633 further drives the rack 24 to move forward, until the positioning bar 26 is blocked by the stopping bar 427 positioned on the front of the base 40. The operation member 82 is released, the resilient member 84 positioned at the front of the operation member 82 is restored to bias the sliding plate 821 back, and the adjusting member 86 is pivoted back. The pole 6336 of the gear 633 is received in the hook 865 positioned at a front of the adjusting member 86.

When the display 20 needs to be closed, the skid-proof bars 827 are pulled rearward, to slide the sliding plate 821 rearward along the guiding slot 424. The guiding poles 826 slide rearward along the guiding holes 426. The resilient member 84 positioned at the rear of the operation member 82 is pressed, to be deformed. The pole 6336 is rotated up about the shaft 6316, to pivot the gear 633 anticlockwise. The gear 633 drives the rack 24 to move rearward. The display 20 is slid rearward relative to the base 40. The adjusting member 86 is blocked between the tab 823 positioned at the front of the operation member 82 and the stopping block 429 positioned at the rear end of the base 40. The opposite ends of the protrusion 6331 slidably abut against the inner surfaces of the clamping portions 6353, deforming the clamping plates 6351. The connecting plates 6352 are blocked by the two pairs of pins 6315. The skid-proof bars 827 are further pushed rearward, until the two opposite ends of the protrusion 6331 are across the middle portions of the clamping plates 6351, the clamping plates 6351 are restored to rotate the protrusion 6331 anticlockwise. The gear 633 further drives the rack 24 to move rearward, until the positioning bar 26 of the display 20 is blocked by the stopping bar 427 positioned on the rear of the base 40. The operation member 82 is released, the resilient member 84 positioned at the rear of the operation member 82 is restored to bias the sliding plate 821 back, and the adjusting member 86 is pivoted back. The pole 6336 of the gear 633 is received in the hook 865 positioned at a rear of the adjusting member 86. The display 20 is fully closed on the base 40.

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An electronic device, comprising:
a base;
a display slidably mounted on the base;
a slide apparatus installed between the base and the display, and comprising a rack mounted to the display, a gear pivotably installed to the base and engaging with the rack, and a clamping member, wherein a protrusion protrudes out from a middle of the gear, a pole protrudes out from the protrusion, an axis of the pole deviates from an axis of the gear, the clamping member comprises two resilient clamping plates sandwiching the protrusion; and
an operation apparatus comprising an operation member slidably installed to the base and an adjusting member rotatably connected between the operation member and the pole;
wherein when the operation member is slid, the adjusting member is driven to rotate the gear and the protrusion, two opposite ends of the protrusion slidably abut against the clamping member, deforming the clamping plates, until the opposite ends of the protrusion are across middle portions of the clamping plates, the clamping plates are restored to rotate the protrusion.

2. The electronic device of claim 1, wherein the slide apparatus further comprises a bracket, the bracket comprises a top surface and a side surface extending down from the top surface, the side surface of the bracket defines a recess, the recess extends through the top surface of the bracket, the gear is pivotably received in the recess, with a part of the gear exposed out of the top surface of the bracket.

3. The electronic device of claim 2, wherein a shaft perpendicularly extends out from a middle of an inner wall of the recess opposite to the side surface, the gear axially defines a shaft hole, the shaft is pivotably inserted in the shaft hole of the gear.

4. The electronic device of claim 2, wherein two pairs of spaced pins extend out from two opposite ends of the side surface and adjacent to the recess, the clamping member further comprises two connecting plates connected between ends of the clamping plates, each of two opposite ends of each clamping plate is slidably sandwiched between the corresponding pair of pins and blocked by the connecting plate.

5. The electronic device of claim 4, wherein each clamping plate comprises a clamping portion and two connecting portions connected between two opposite ends of the clamping portion and the connecting plates, the protrusion is sandwiched between the clamping portions of the clamping plates, the connecting portions are slidably sandwiched between the corresponding pins.

6. The electronic device of claim 5, wherein each clamping portion is arc-shaped, the clamping portion arcs away from the opposite clamping plate, the clamping portions cooperatively bound a clamping space for receiving the protrusion of the gear.

7. The electronic device of claim 5, wherein each connecting portion is C-shaped, and protrudes away from the clamping plates.

8. The electronic device of claim 3, wherein the protrusion is ellipse-shaped, the shaft hole extends through a middle of the protrusion, the pole extends from one of the ends of the protrusion away from the shaft hole.

9. The electronic device of claim 1, wherein the operation member comprises a sliding plate and a connecting shaft protruding from a middle portion of the sliding plate toward the base, the adjusting member comprises a C-shaped rotation portion pivotably fitted about the connecting shaft, two connecting pieces slantingly extending down and away from each other from two opposite distal ends of the rotation portion, and two hooks formed on distal ends of the connecting pieces, the pole of the gear is operable of being latched with one of the hooks.

10. The electronic device of claim 9, wherein a top surface of the base defines a receiving space, the receiving space is located in a side of the base, the side of the base defines a guiding slot communicating with the receiving space, the bracket is received in the receiving space, the operation member is slidably received in the guiding slot.

11. The electronic device of claim 10, wherein the base defines two opposite guiding holes in a junction of the receiving space and the guiding slot, the operation member further comprises two pieces protruding out from the sliding plate and adjacent to the connecting shaft, and two guiding poles extending from the pieces away from each other, the guiding poles are slidably inserted in the guiding holes, the operation member further comprises two resilient members fitting about the guiding poles.

12. The electronic device of claim 11, wherein the operation member further comprises two spaced tabs protruding out from the sliding plate between the pieces, the connecting shaft is located between the tabs, two opposite stopping blocks are formed on two opposite ends of a bottom of the junction of the receiving space and the guiding slot, the connecting pieces of the adjusting member are blocked between the tabs and the stopping blocks.

13. The electronic device of claim 1, wherein two spaced stopping bars protrude up from the base, a positioning bar protrudes down from the display, the positioning bar is stopped between the stopping bars of the base.

14. The electronic device of claim 1, wherein the clamping member is made of resilient material.
